(19) United States
(12) Patent Application Publication
(10) Pub. No.: US 2005/0215303 A1
(43) Pub. Date: Sep. 29, 2005

(54) Game machine

(76) Inventor: Haruo Inoue, Tokyo (JP)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 11/120,996

(22) Filed: May 4, 2005

(30) Foreign Application Priority Data
Jan. 31, 2005 (JP) 2005-023141
Apr. 8, 1998 (JP) H10-96281
Jun. 26, 2002 (JP) 2002-185493

(51) Int. Cl. A63F 13/00

(52) U.S. Cl. 463/16

(57) ABSTRACT

The game machine includes a first display device, including a display body, indicating selectively an information for a game content and a symbol display window by moving in a predetermined direction to a front side of a case; a second display device which is arranged at a back side of the first display device, being in relation with a stop position of the symbol display window, having the display bodies for playing the game; a control part which controls the display bodies of the display devices respectively; and the display bodies which move corresponding to a condition of the game and allow the display bodies of the second display device to be indicated through the symbol display window in the case that the game can be played. Therefore, there is an appeal for the sight of player, and the display part of the game machine is used effectively.

### FIELD OF THE INVENTION

This invention relates to a game machine that provides with a display body to display information to play the game, including dividend information, information how to play the game and the like.

### BACKGROUND OF THE INVENTION

The game machine called pachinko and slot machine is installed the display device with the display body to play the game into the case with the front panel. For example, the symbol display device for the game machine that has the single display body in the upper part of the case as shown in the reference document 1 is installed thereinto in the slot machine that is a kind of the game machine in. The symbol display device of this reference document 1 includes reel display part which is attached rotatably into the support member formed in the shape of the cover card and the reel drive part which allows the support member to rotate in a predetermined direction.

One of the display bodies, which are formed in the shape of a disc, of the reel display part has a first display part (front face) to play the first game for deciding dividend (dividend-decision game) and a second display part (circumferential surface) to play the second game for increasing dividend (double-up game). In addition, the reel drive part responds to fulfill a predetermined requirement with the first game, and the rotation position is controlled by the control part so as to display the second display part.

Therefore, the symbol display device in the reference document 1 has the function to display the two contents of the game with one display body. This game machine resolves the problem of the prior art that the displayed content of the display part (it is called “GYOTO” part in general) at the upper position in the slot machine is limited to one kind of the contents and has the advantage that it gives the change to the displayed content of the game and expands the content of the game. Moreover, there is an appeal for the sight of player because the rotation position of the display body for the game execution changes in the place.

However, for the reference document 1, although the game is operated by using the display part at the upper position of the game machine, it is not able to be displayed enough information to play the game including dividend information, information haw to play the game and the like.

In addition, the game machine described in the reference document 2 includes a display device which displays the image for the game; a combiner (half mirror) which reflects displayed light; a georama which is provided at the back pant of the combiner, and a display body which displays the background of the georama by using the reflection The display body is described that it is reeled off the drive shaft and allowed the background to change in series. However, for the game machine in the reference document 2, although the display body is reeled by the drive shaft, it has the same problem of the reference document 1.

Reference document 1: Unexamined patent application publication 2004-24554; and

Reference document 2: Unexamined patent application publication Hei 11-295639.

### SUMMARY OF THE INVENTION

Accordingly, it is an object of the present invention to provide a game machine which can display information to play the game including dividend information, information how to play the game and the like. It is another object of the present invention to provide a game machine that can be produced that the display body is moved corresponding to the state of the game such as starting the game, fulfillment of a predetermined condition and the game starts at once. It is another object of the present invention to provide a game machine that can return the original image for supplying information after the display body is moved again when the game is finished. This gives that the display part of the game machine is used effectively and gives the players the unpredictable quality and ingenious plan. It is another object of the present invention to provide a game machine that allows the display body to move with rational system. It is still another object of the present invention to provide a game machine which can boost the variation of the game in relation with the game of the second and third display device.

The present invention is understood to encompass embodiments which include all or only a portion of the above objects, features and advantages which, unless recited in claims defining the invention, are understood not to limit interpretation of such claims. The above, and other objects, features and advantages of the present invention will become apparent from the following description read in conjunction with the accompanying drawings, in which like reference numerals designate the same elements.

It is to be expressly understood, however, that the drawings are for the purpose of illustration and description only, and are not intended as a definition of the limits of the invention.

### BRIEF DESCRIPTION OF THE DRAWINGS

FIGS. 1 to 9 illustrate explanation views showing a first embodiment of the present invention respectively. FIGS. 10 and 11 is a view of a second embodiment of the present invention;

FIG. 1 is a perspective view of an example of a game machine showing the present invention;

FIG. 2 is a schematic explanation view of a power supply circuit;

FIG. 3 is a schematic explanation view showing the way in which a display body, which is formed in the shape of a belt, of a first display device moves;

FIG. 4 is a schematic view showing the way in which a display body stops in front of a game machine;

FIG. 5 is a schematic explanation view of a first detective means;

FIG. 6 is an explanation view of main parts (support member, shaft, display body and drive motor);

FIG. 7 is an explanation view from a plan view based on FIG. 6;

FIG. 8 is an explanation view from a bottom view based on FIG. 6;

FIG. 9 is a schematic cross-sectional view taken on line 9-9 of FIG. 7;

FIG. 10 is a schematic explanation view, as the same as FIG. 3, showing a second embodiment of the present invention;

FIG. 11 is a schematic explanation view showing the way in which a display body is provided to a drive shaft and parallel shaft in an open shape;

FIG. 12 is an explanation view showing the in which a second display device is a video type; and

FIG. 13 is an explanation view showing the in which a second display device is a circular plate.

### DETAILED DESCRIPTION OF THE PREFERRED EMBODIMENTS

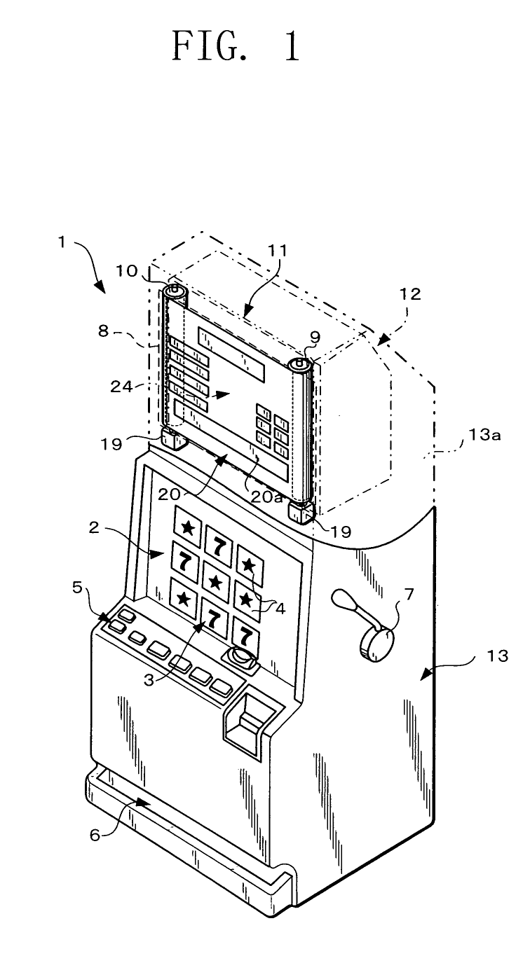

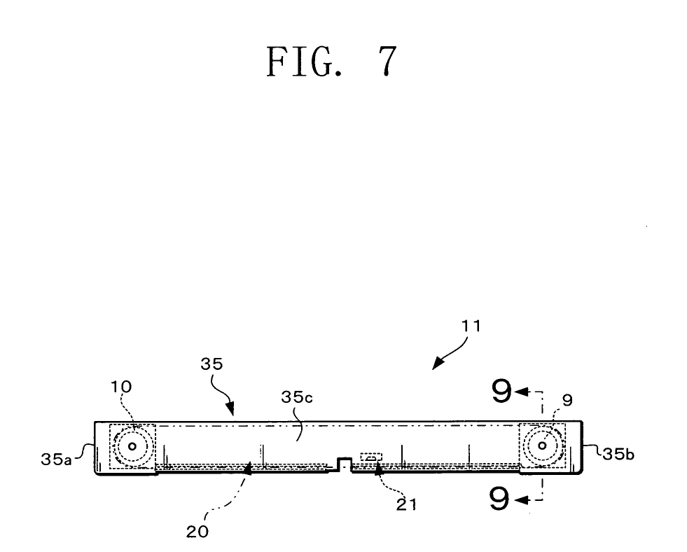

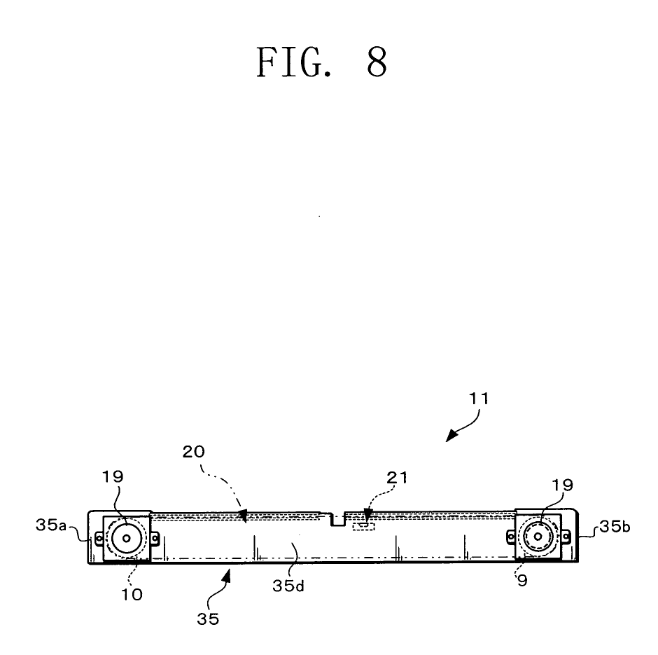

An understanding of the present invention may be best gained by reference FIGS. 1 to 9.

(1) OBVIOUS MATTER

First of all, when it explains the game machine of this invention, the obvious matter for the persons skilled in the art is included in the content of the description of this specification. For example, the slot machine that is one example of the game machine can execute the game by turning on the game medium (coin). The game medium includes the token such as medals and coins and the credit multiplied in a storage part. Moreover, when the start button and the start lever are operated after the game medium is turned on, the movement display of the symbol is carried out in the slot machine. In addition, when the reel stopped automatically after the predetermined time passes or stopped after the stop button of the machine type reel or pseudo type reel is operated, the combination of the symbol is decided on the line of winning a prize. The kind of wining a prize, the existence or nonexistence of winning a prize, the dividend rate when the winning a prize is taken place, the shift condition to the second game (sub game) are the obvious matters for the persons skilled in the art, and the detailed explanation is omitted here. Next, it explains about an essential matter (includes a related matter) of this invention.

(2) ESSENTIAL AND RELATED MATTERS

The reference numeral 1 is a slot machine which is comprised basically of a first display device 11 and second display device 12 which are installed in an upper part 13a (includes a part positioned at the front portion of the upper part 13a) of a case 13 of the game machine1; a third display device 2 installed in a lower part of the first display device 11 and second display device 12; and a power supply circuit 15 which drives and controls the display device 2, 11 and 12.

The first display device 11 and second display device 12 are provided at a part which is called “GYOTO” part generally, the third display device 2 is provided at a center part of the game machine 1 to operate the main game. In addition, when the slot machine 1 does not have the third display device 2, the first and second display devices are installed in a preferable place adjacent a front part of the game machine 1 since the second display device 12 is used to operate the main game.

First, FIG. 1 shows a general appearance of the slot machine 1. In FIG. 1, the reference numeral 2 is the third display device with the display body 3 for the game which corresponds to the reel-typed display device or display device for symbol image. As the common knowledge of one skilled in the art, a control panel 5, a coin return 6 or the like are set at the slot machine 1. A start lever 7 is set up the side face of the case of the slot machine 1.

The reference numeral 8 is a transparent front panel which is set at the upper part of the case; the reference numeral 11 is the first display device which is set to the back surface of the front panel 8; the reference numeral 12 is the second display device which is arranged in association with the stop position in a front display window part 20b of a display body 20, which is formed in the shape of a belt, of the first display device 11, having a back display body 24 to operate the game. Here, the display body 20 of the first display device 11 is arranged in relation with the rotation position (or drawn position) of the symbol, which is not shown, of the back display body 24 of the second display device 12 when the backward display body 24 of the second display device 12 is based because the phrase of “it is set in relation to the stop position” means the explanation based on the forward display window 20b of the first display device 11. In addition, the display window of the third display device 2, line of winning a prize or the like are not explained in this embodiment.

For the above-mentioned structure, one of the first drive motors 19 of the first display device 11 at the upper part acts, the display body 20 moves to the right direction horizontally through the drive shaft 9 which is positioned at the right side of the front panel 8 and the parallel shaft 10 (drive shaft) which is positioned at the left side of the panel 8, and the forward display window 20b (hereinafter referred to as symbol display window) is indicated (this embodiment) when the main game (slot machine game) is started at the third display device 2 for example and the predetermined condition is satisfied in the main game. Therefore, the sub game (double-up game, for example) can be operated by the back display body 24 (reel, display screen, circular plate etc.) of the second display device 12 which is positioned at the backside of the symbol display window 20b.

(3) POWER SUPPLY CIRCUIT

A power supply circuit 15 in this embodiment includes a power supply, a control part 16 which controls a drive motor by the current from the power supply and means for detecting which detects rotation-position angle of the drive motor 19, 23 in the general meaning. It is enough that the control part 16, as shown in FIG. 1, controls order and operation (activate and deactivate). Therefore, when the words of “power supply circuit 15” is defined narrowly, it does not include the control part, drive motor and the like, and it means the commercial power supply, electrifiable battery, pressor circuit and the like which are not shown in the figures.

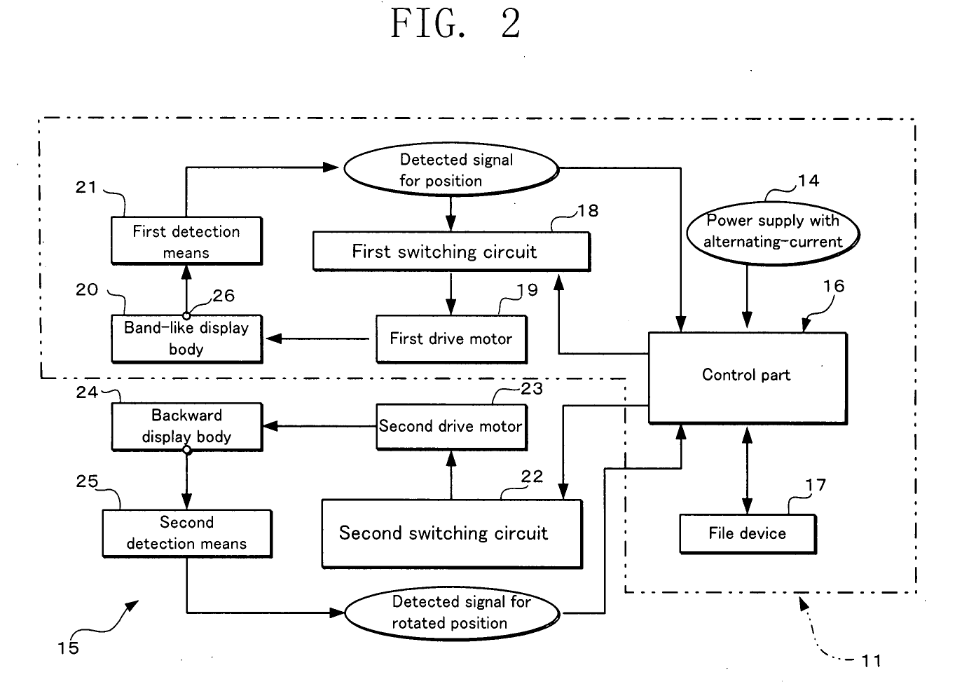

Before the first display device is explained, the power supply circuit 15 is explained in reference to FIG. 2. The power supply circuit 15 has the control part 16 which drives and controls the action of the display bodies 3, 20 and 24 of the first second and third display devices 2, 11 and 12, and one of the features in the present invention is to combine the display body 20 of the first display device 11, the back display body 24 of the second display device 12 so that the details of the electric circuit for the third display device 2 is omitted.

The control part 16 (microcomputer) is installed in the upper part 13a of the case of the game machine 1 through the printed-circuit board In addition, in reference to FIG. 2, the reference numerals are marked to the composition n relation to the first display device 11 and second display device.

The reference numeral 14 is an alternating current; reference numeral 17 is a file device; reference numeral 18 is a first switching circuit; reference numeral 19 is a first drive motor, reference numeral 20 is a display body; and reference numeral 21 is a first detective means. These circuits and member define the first display device 11 with the drive shaft 9 and parallel shaft.

In addition, the reference numeral 22 is a second switching circuit; reference numeral 23 is a second drive motor (stepping motor, foe example); reference numeral 24 is a back display body; and reference numeral 25 is a second detective means. These circuits and member define the second display device 12 with the support member, which is not shown, and guidance member. In addition, here, the word of “first” does not mean just one piece, and it is used for distinguishing the composition of the second display device 12. Therefore, the firs drive motor, first switching circuit and first detective means 21 are installed plurally according to need.

And now, the display body 20 moves to the right direction horizontally through the drive shaft 9 which is positioned adjacent the front panel 8 and the parallel shaft 10 (drive shaft) after the upper first display device 11 of the first drive motor 19 when the slot machine game is started at the third display device 2 and the predetermined condition is satisfied in the game.

And so, it is referred to that point. The display body 20 gives information 20a (part) for game content the status of the front panel 8 (such condition shown in FIG. 1) before the predetermined condition is satisfied during the slot machine game is operated.

When the control pail 16 receives the signal which is satisfied the predetermined condition, it controls to turn on the first switching circuit and to flow current of the alternating-current power supply 14 to the first drive motor 19 of the drive shaft 9. The alternating-current power supply 14 is changed to direct current by the AC/DC converter which is not shown, and the direct current is output as alternating-current through the first switching circuit 18 (bridge inverter, for example). The drive force of the first drive motor 19 is transmitted to the drive shaft 9 (according to the designing, the drive force is transmitted to the drive shaft 9 through the gear with a function for speed reduction).

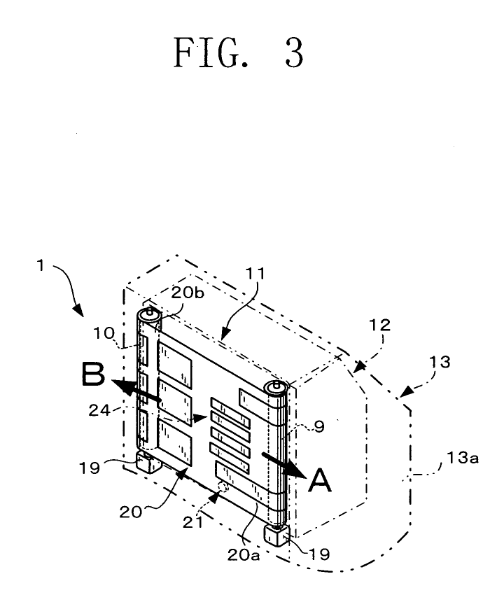

When the right drive shaft 9 shown in FIG. 3 rotates, the display body is rewound the drive shaft 9 from one end part thereof, and it moves to the arrow direction (this embodiment).

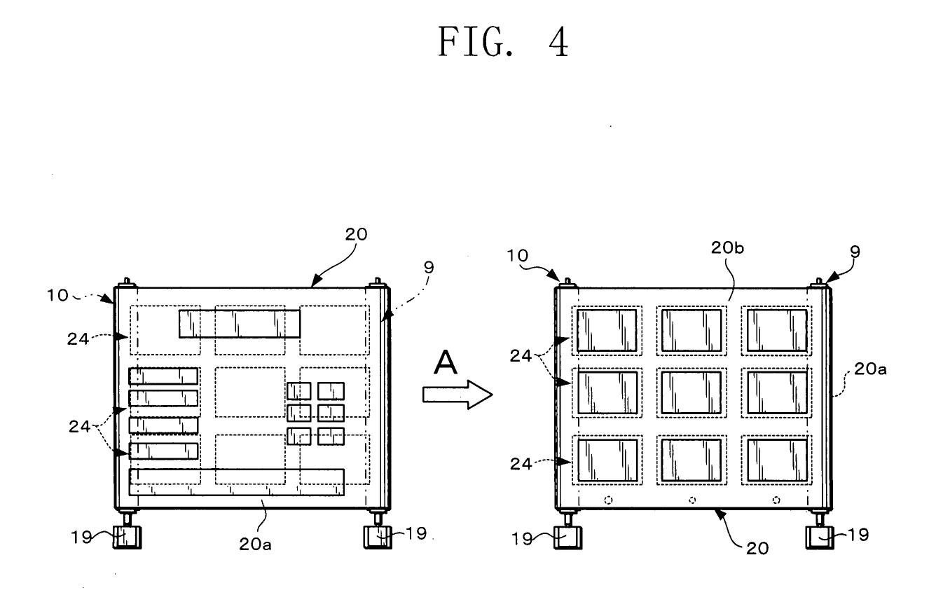

Therefore, information 20a for the game content of the display body 20 moves to the right side, and the forward symbol display window 20b which is positioned at another side connected to the information 20a is indicated at the part adjacent the front panel 8 (see FIG. 3). Then, based on the view point of the player, each window, which is formed in the shape of a matrix, of the symbol display window 20b of the display body 20 just stops conveniently at the point which faces to the symbol, which is not shown, of each back display body 24 of the second display device 12 (see FIG. 4).

The display body 20 stops after the control part 16 gets the detective signal of the first detective means 21 and the first switching circuit 18 is turned off.

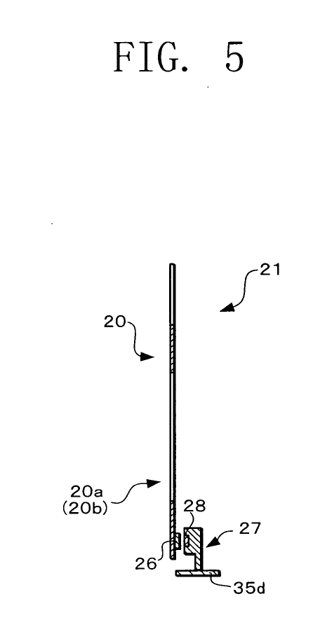

FIG. 5 shows one of examples for the detective means 21 for the display body 20, detecting the moving position. In this embodiment, when the display body is rewound by the drive shaft 9 (that is, the parallel shaft 10 sends the display body 20) or when the parallel shaft 10 rewinds the display body 20 (that is, the drive shaft 9 sends the display body 20). It needs to stop the symbol display window 20b and information 20a for the game contents at the predetermined position. Of course, the spring, which is not shown, may be installed at the side of the parallel shaft 10 without the first drive motor to the parallel shaft 10 as the invention is described in the reference document 2.

Then, a signal output part 26 (magnet, for example) is attached fixedly to the edge portion (lower end portion, for example) of the display body 20, and a hall element 28 is attached fixedly to an attachment piece 27 which is fixed to the part adjacent the case 13. One first detective means 21 or the plurality of first detective means 21 are arranged at the predetermined position of the fixation member. When the display body 20 moves horizontally and it faces the hall element 28, it senses the flux of N pole of the magnet 26 and outputs the signal for position to the control part 16.

In addition, the first detective means 21 using a principal of a hall IC, a combination of light emitting element and light-sensitive element or the like is applied selectively.

When the symbol display window 20b of the display body 20 is indicated in the front side, the game in the second display device 12 can start. Then, the control part 16 controls the second switching circuit 22, second drive motor 23, backward display body 24 etc. of the second display device based on the program for the second game in the file device 17. When the second game finished, the control part 16 turns on the first switching circuit 18 and runs the first drive motor 19 of the parallel shaft 10 (drive shaft). After the fist drive motor 19 is run, the display body 20 moves to the arrow B in FIG. 3. In addition, the control part 16 receives the signal from the first detective means 21 and turns off the first switching circuit 18.

As described above, in this embodiment, the game machine includes the first display device 11 with the display body 20, which is formed in the shape of a bar, which indicates selectively information 20a for the game content and symbol display window 20b by moving in a predetermined direction to the front side of the case; the second display device 12 with the display body 24 for playing the game, arranging at the back side of the first display device, in relation with the stop position of the symbol display window 20a; the control part 16 which controls the display bodies 20, 24 of the display devices 11,12 respectively. In addition, the display body 20 moves corresponding to the condition of the game and allows the display body 24 of the second display device 12 to be indicated through the symbol display window 20a in the case that the game can play.

(4) SPECIFIC COMPOSITION OF FIRST DISPLAY DEVICE

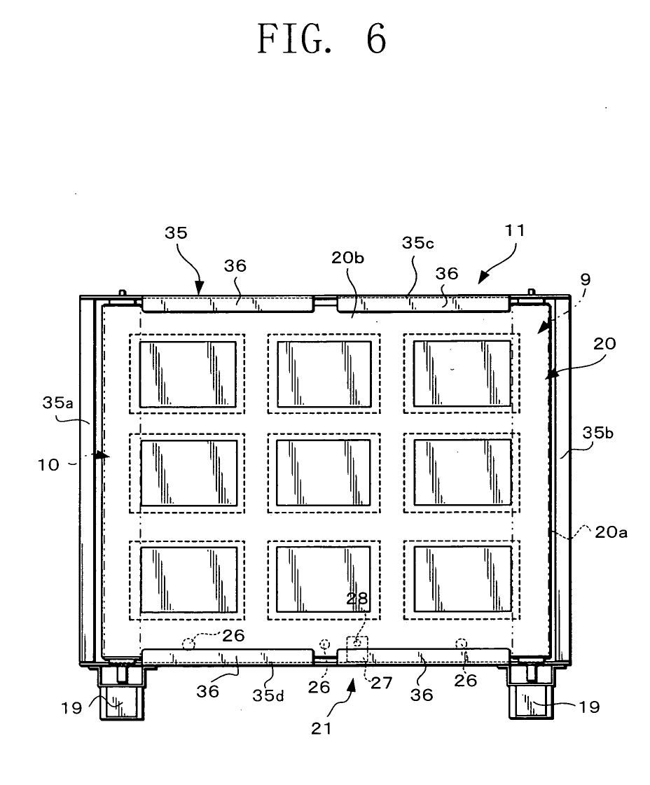

In reference to FIGS. 6 to 9, the specific composition of the first display device 11 is explained. The first display device 11 is installed in the interior of the upper part 13a of the case 13 integrally or detachably through the support member 35 with the frame structure and the plurality of the drive shaft 9 and 10. The information 20a for the game content and symbol display window 20b of the display body 20 moves to the rewinding direction of the display body 20 by the drive force of the first drive motor 19 which is connected directly with the drive shafts 9, 10. As mentioned above, in this embodiment, after one of the shafts 9 rewinds the display body 20, another shaft 10 gets off the display body 20.

The composition of the support member 35 is marked based on FIG. 6. The reference numeral 35a is a left flame; reference numeral 35b is a right flame; reference numeral 35c is an upper frame; and reference numeral 35d is a lower flame. Therefore, the support member 35 is formed in the shape of a rectangle flame. The explanation for details of the support member 35 is omitted.

And now, a plurality of guide pieces 36 is formed at an upper and lower frames 35c, 35d of the support member 35. The guide pieces 36 guides the upper and lower end parts of the display body 20 at the binding state, forming in the shape of a U-letter in end section and a contra-U-letter in end section. As shown in FIG. 6, the guide piece 36 is preferably formed in the shape of a long along the upper and lower flames 35c, 35d. In addition, the attachment piece 27 of the first detective means 21 is fixed to the center portion of the lower flame 35d.

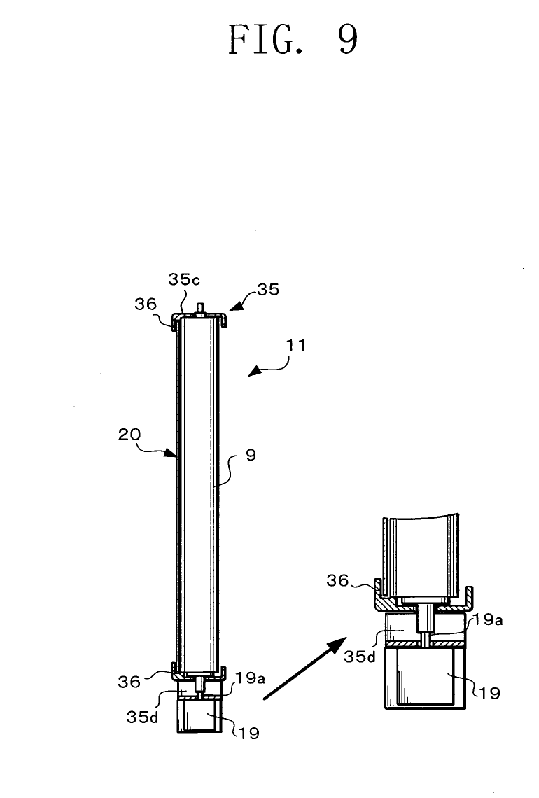

As shown in FIG. 9, the right and left shafts 10, 9 are supported rotatably and vertically by the support member 35 and connect an output shaft 19a of the first drive motor 19 to the projecting end part thereof For the connection structure, the engagement part (square hole) is formed at the projected end part of the drive shaft (parallel shaft) 9, 10, and the output shaft 19a engages to the engagement part.

And now, the display body 12 is formed of a cloth, plastic, rubber and the like. It is formed preferably a lucent synthetic resin with the predetermined length (length that the position of the information 20 and display window 20b can change alternatively). In addition, the display body 12 is formed widely and comparatively so as to cover wholly the display body 24 of the second display device 12 (FIG. 1).

In this embodiment, the dividend information is described as one of examples for information of the game contents. Of course, the instruction for the game and trademark of the game machine may be indicated with the exception of the dividend information. The dividend information is indicated preferably at least one side part thereof The dividend rate, number of dividend that the player gets and the like are illustrated in the dividend information.

(5) DETAILS FOR SECOND DISPLAY DEVICE

In this embodiment, the display body 24 of the second display device is defined by the mechanical reel unit, including nine reels with symbol, which is not shown, at the circumferential part thereof.

Therefore, nine display windows (frame line or opening) are formed, which is formed in the shape of a matrix, corresponding to the position and number of the back display body 24 in the symbol display window 20b of the first display device 11.

And now, the symbol which is indicated the mark, sign, number, design, character and so on is displayed at the circumferential part of the display body 24. The display bodies 20, 24 of the first display device 11 and second display device act respectively, the action mode (activation, stop) is decided according to the condition of the game. The changing relationship that the slot machine game which is operated by the third display device 2 and sub-game which is operated by the second display device 12 is the common knowledge of one skilled in the art known so that the detailed explanation is omitted.

In the mode of the embodiment, although the forward symbol display window 20b of the display body 20 is zoned nine parts, this number corresponds to the number of the backward display body 24 of the second display device 12. Therefore, when the backward display body 24 of the second display device 12 juxtapose at three pieces to the horizontal direction, which is not shown in the figure especially, the forward symbol display window 20b is zoned three pieces by the frame line or opening. Therefore, the forward symbol display window 20b is formed single number or plural number.

In addition, the display body 20 moves to the right and left directions since the drive shaft 9 and parallel shaft 10 are provided at vertical state. However, the moving direction is not limited. That is, the drive shaft 9 and parallel shaft 10 may be provided at upper and lower part in the horizontal state along the upper support frame 35c and lower support frame 35d. In this case, the display body 20 moves to the vertical direction.

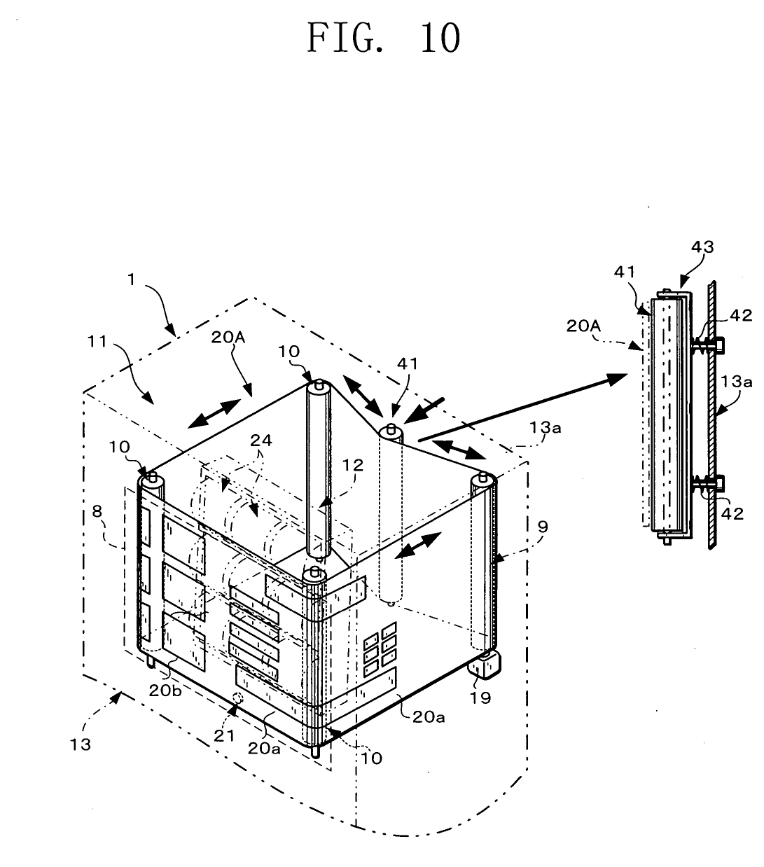

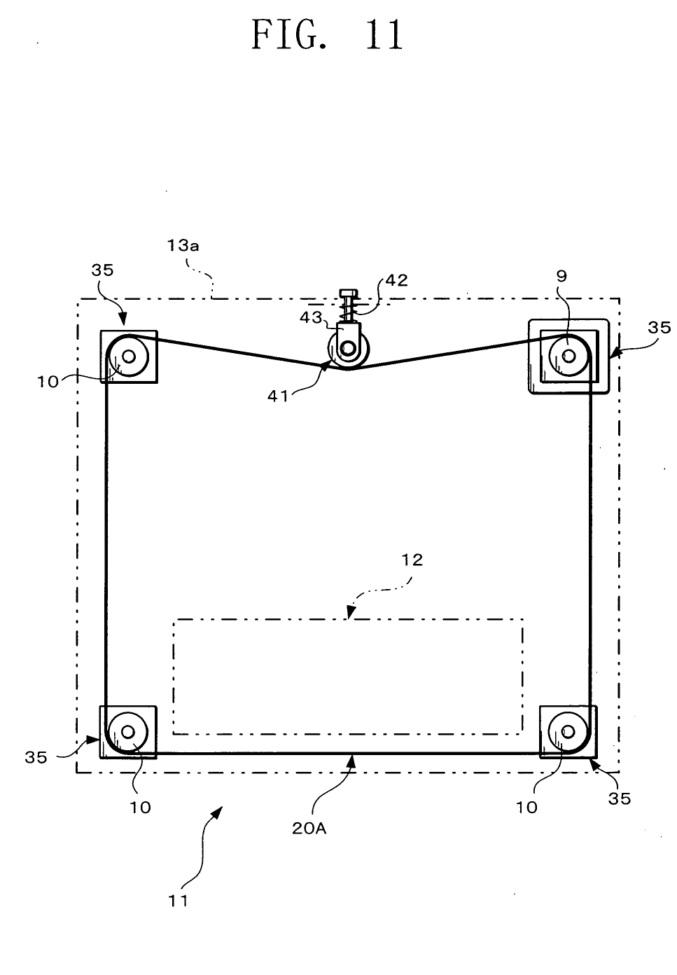

In this paragraph, other embodiments of the present invention will now be described FIG. 10 is the schematic explanation view showing the second embodiment with the same figure as FIG. 3. FIG. 11 is the schematic explanation view showing the way in which a display body 20A is attached to the drive shaft 9 and three parallel shafts 10 openly. As is clear from these figures, in the second embodiment, the shaft that is connected directly to the first drive motor 19 is called the drive shaft 9, and other three parallel shafts are defined by the driven shaft 10. The display body 20A is attached openly with tension to the shafts 9, 10 a little.

The difference between the first embodiment and second embodiment is that the upper part 13a is the case 13 is large; the display body 20A is a rotation type; a guide roller 41 for tension to the display body 20A is attached to the back side of the upper part 13a; number of the parallel shaft 10 is large; and number of the first drive motor 19 is at least one.

However, these differences are not essential matter of the present invention. In addition, the guide roller 41 includes means for biasing with a plurality of springs 42. Furthermore, although the display body 20 A rotates with friction drag, a plurality of engagement parts is formed at the upper and lower end parts of the display body 20A, and the engagement parts are engaged with the engaging parts which are provided at the circumferential part of the shafts 9, 10 (not shown in the figure).

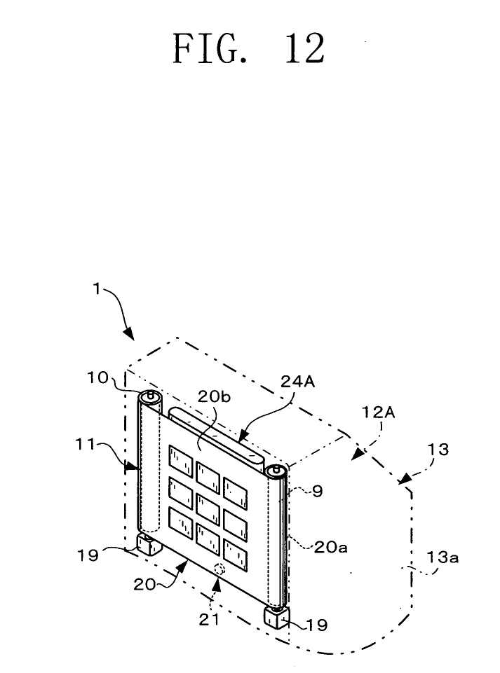

FIG. 12 shows the way in which the display body 24A of the second display device 12A is formed in the shape of a video type. The second display device 12A restages with pseudo the rotation of the reel by displaying the condition of movement of the symbol on the display body 24A (CRT etc.) based on the graphic data in the file device (ROM) as common knowledge of one skilled in the art. The structure and function of the second display device 12A is the common knowledge of one skilled in the art known so that the detailed explanation is omitted.

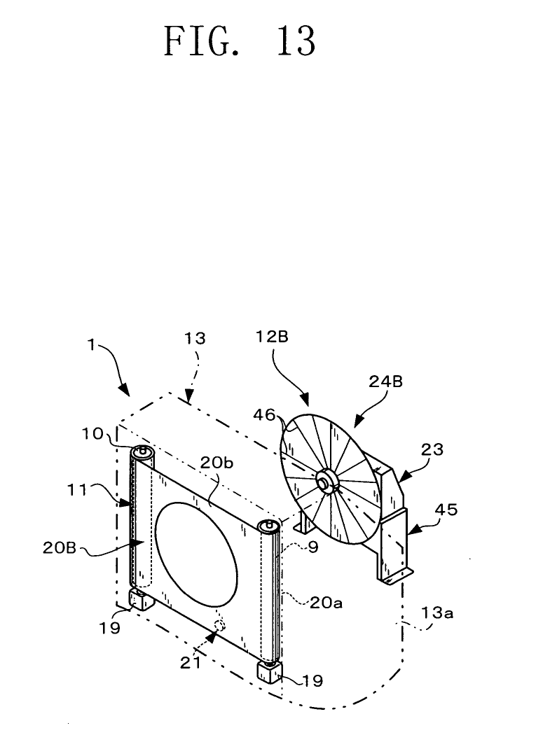

FIG. 13 shows the way in which the second display device 12B is formed in the shape of a circular plate. In this embodiment, it is called “system of lottery”. More specifically, the second display device 12B includes a support member 45 which is formed in the shape of a gate; the second drive motor 23 which is attached fixedly and horizontally to the upper surface of the support member 45; a backward display body 24B, which is formed in the shape of a circular plate, which is connected with the output shaft of the drive motor 23. Lines 46, which divide radially, are provided in a surface of the backward display body 24B, and the number of the coins as dividend which is not shown is indicated at the parts between the lines 46.

Therefore, the shape of the forward symbol display window 20b of the display body 20B in the first display device corresponds to the shape and size of the backward display body 24B.

In this way, according to the mode of the display bodies 24, 24A and 24B of the second display device 12, 12A and 12B, the shape of the symbol display window 20b of the first display device may be changed. However, the essential matter of the invention is not changed.

The present invention is used for the business field of the game machine including Japanese pinball, slot machines or the like.

As set forth above, the advantages of the invention are as follows:

(1) Information for playing the game including the dividend information, way to play the game and so on can be indicated at the part (upper part, for example) of the game machine. The display body moves corresponding to the game condition including activate state, satisfaction for the predetermined condition and so on, the starting condition is made quickly. In addition, when the game finished, the display body is moved again and can return to the original information stage.

(2) As discussed above, the display part of the game machine can be put to practical use, and it can give the players the unpredictable quality and ingenious plan and player.

(3) As discussed above, since the display body can be moved through the drive shaft and parallel shaft which are supported by the support member, it can be achieved the purpose by the easy and rational structure.

(4) As discussed above, when the guide piece guides the display body is provided at the support member, it can move with keeping the shape of the display body

(5) As discussed above, it can boost the variation of the game in relation with the game of the second and third display device.

1-7. (canceled)

8. A game machine comprising:
a first display device, including a display body, which is formed in the shape of a bar, indicating selectively an information for a game content and a symbol display window by moving in a predetermined direction to a front side of a case;
a second display device which is arranged at a back side of said first display device, being in relation with a stop position of said symbol display window, having display bodies for playing said game;
a control part which controls display bodies of said display devices respectively; and
said display bodies which move corresponding to a condition of said game and allow said display bodies of said second display device to be indicated through said symbol display window in the case that said game can be played.

9. The game machine according to claim 8, wherein said first display device further includes a first detecting means; a first switching circuit which is controlled to turn on and off by a control part based on a detected signal that said detecting means senses; and a first drive motor which is started and stopped by said switching circuit.

10. The game machine according to claim 8, wherein said display bodies, which are formed in the shape of a bar, of said first display device are installed in an upper part of said game machine through a support member, a drive shaft and a parallel shaft which are supported pivotably at a predetermined intervals against said support member.

11. The game machine according to claim 10, wherein said support member of said first display device is formed guide pieces which guides upper and lower end parts of said display body.

12. The game machine according to claim 8, wherein said information for said game content in said display body includes an indication for a dividend information at least.

13. The game machine according to claim 8, wherein said first display device includes a third display device with a display body for said game, forming at a lower part thereof, starting said drive motor of said first display device when a predetermined condition is satisfied in the situation of a game which is played in said third display device.

14. The game machine according to claim 8, wherein said display body of said second display device is one of a reel with a mechanical reel unit, a display screen, which is formed in the shape of a video type, displaying a graphic data in a file device with pseudo and a circular plate which rotates by drive force of said second drive motor.
